(19) United States
(12) Patent Application Publication
(10) Pub. No.: US 2002/0089679 A1
(43) Pub. Date: Jul. 11, 2002

(54) Color separating/synthesizing apparatus

(75) Inventors: Jong Su Yi, Suwon-Shi (KR); Jong Myoung Park, Anyang-Shi (KR)

Correspondence Address: DARBY & DARBY P.C., 805 Third Avenue, New York, NY, 10022, US

(73) Assignee: SAMSUNG ELECTRO-MECHANICS CO., LTD., SUWON-SHI (KR)

(21) Appl. No.: 09/855,874

(22) Filed: May 15, 2001

(30) Foreign Application Priority Data
Dec. 22, 2000 (KR) 2000-80038

(51) Int. Cl. B41J 1/00

(52) U.S. Cl. 358/1.9

(57) ABSTRACT

Disclosed a color separating/synthesizing apparatus which is configured to avoid a degradation in contrast depending on the performance of its polarized beam splitter, to eliminate the cause of the requirement of simplifying the design of its projection unit as much as possible in order to minimize the occurrence of an interference phenomenon involved in the case in which one reflective LCD is arranged at one side surface of a light exit, and to allow incident and outgoing light beams to have a relation of 90°, thereby allowing its projection lens to have a more compact mechanical position.

### BACKGROUND OF THE INVENTION

1. Field of the Invention

The present invention relates to a projection system, and more particularly to a color separating/synthesizing apparatus which is configured to allow incident and outgoing light beams to have a relation of 90°, thereby allowing its projection lens to have a more compact mechanical position.

2. Description of the Prior Art

In pace with the development of large-scale displays, the development of data projectors, projection TVs, and projection monitors, which use projection techniques, have been accelerated. Recently, research has been made in association with reflective liquid crystal panels including a reflective electrode arranged at each pixel to achieve an improvement of the aspect ratio of the pixel. Also, application of such reflective liquid crystal panels to projection type liquid crystal projectors have been made. Reflective liquid crystal panels can make it possible to realize miniature projectors having a high efficiency because they provide an improved aspect ratio, as compared to conventional transmission type liquid crystal panels.

The above mentioned projection system mainly includes an illumination unit, a color separating/synthesizing unit, and a projection unit. Where such a projection system uses a three-plate type reflective liquid crystal display (LCD), its color separating/synthesizing unit may be the most important element for an improvement in the contrast of the screen.

The color separating/synthesizing unit may include a Color Coner™, a Philips prism, a Color Quad TM, or an X-prism. These configurations for the color separating/synthesizing unit are illustrated in FIGS. 1 to 4, respectively.

FIG. 1 illustrates a conventional projection system using a Color Coner™ as its color synthesizing/synthesizing unit. Now, the operation of this projection system will be described in conjunction with FIG. 1. Non-polarized white light emitted from a lamp 11 is splitted into P and S waves by a polarization means (not shown).

The polarized light is then incident to a first color selecting retarder CS1. The first color selecting retarder CS1 serves to polarize G (green)-color light beams into P waves while transmitting S-polarized light beams therethrough. A polarized beam splitter, which is denoted by the reference character PBS, is arranged downstream from the first color selecting retarder CS1. The polarized beam splitter PBS allows P-polarized G-color light components of the light incident thereto after being transmitted through the first color selecting polarization plate CS1 to be transmitted therethrough while reflecting the remaining components of the incident light, thereby changing the travel direction of the remaining light components.

A dichroic filter DIC is arranged downstream from the polarized beam splitter PBS to separate B (blue) and R (red)-color components from the light reflected by the polarized beam splitter PBS. The P-polarized G-color light beams transmitted through the polarized beam splitter PBS, and the B and R-color light beams separated by the dichroic filter DIC are projected onto reflective LCDs 15G, 15B, and 15R, respectively, and then reflected by those reflective LCDs 15G, 15B, and 15R while containing images respectively corresponding thereto. Finally, the image-containing R, G, and B-color light beams are incident to a projection unit 16.

Where a Color Coner™ is used as the color separating/synthesizing unit of the projection system, as mentioned above, there may be a reflection difference between the P and S waves due to the performance of the dichroic filter DIC, thereby resulting in a loss of light. Furthermore, a reduction in contrast occurs because one polarized beam splitter PBS and color selecting retarders or retarder stacks CS1 and CS2, as polarization elements, are used.

FIG. 2 briefly illustrates a conventional projection system using a Philips prism as its color synthesizing/synthesizing unit. Now, the operation of this projection system will be described in conjunction with FIG. 2. S-polarized light beams splitted from light emitted from a lamp 11 is reflected by a polarized beam splitter 13, and then sequentially splitted into a plurality of desired color light components such as red, green, and blue-color light components. A prism assembly not denoted by any reference numeral is also provided to allow the three color light components to be incident to three reflective LCDs 15R, 15G, and 15B, respectively.

The prism assembly includes three prisms spaced from one another by a desired angle while providing two color separation surfaces. A dichroic coating is formed on each color separation surface in order to achieve a desired color separation.

Where such a Philips prism is used as the color separating/synthesizing unit of the projection system, each element of the system should have a very sophisticated structure, as shown in FIG. 2. As a result, there is a difficulty in manufacturing the projection system. This may result in an increase in the manufacturing cost. In similar to the case using the Color Coner™, there may be a reflection difference between the P and S waves at each color separation surface formed with a dichroic coating, thereby resulting in a loss of light. Furthermore, there is a considerable deviation depending on the performance of the dichroic coating. For this reason, it is difficult to apply this system to a projector using an LCD which is a polarization element.

FIG. 3 illustrates a conventional projection system using a Color Quad™ as its color separating/synthesizing unit. Now, the operation of this projection system will be described in conjunction with FIG. 3. S-polarized light beams splitted from light emitted from a lamp 11 is incident to a green-color selecting retarder GR which converts green components of the incident light into P waves. The P-polarized light is then directed to an associated one of four polarized beam splitters included in a Color Quad™, that is, a polarized beam splitter PI.

The color selecting retarder, which is so called a “retarder stack”, has characteristics for converting the polarization state of a particular light component selected from R, G, and B light components of incident light in the manufacture of the color selecting retarder. For example, in the case of a red-color selecting retarder, it serves to convert the polarization state of only the R-color component included in an incident light while maintaining the polarization states of the remaining color components.

Accordingly, the polarized beam splitter P1 serves to transmit the green-color component of the incident light therethrough while reflecting the remaining blue and red-color components. Thus, a color separation for the incident light is achieved. The blue and red-color components reflected by the polarized beam splitter P1 are then incident to a red-color selecting retarder RR which, in turn, converts red components of the incident light into P waves. The P-polarized light is then directed to an associated one of the four polarized beam splitters included in the Color Quad™, that is, a polarized beam splitter P2.

Thus, respective R, G, and B-color components of light have different travel paths by virtue of the Color Quad™. In the following description, the four polarized beam splitters included in the Color Quad™ will be simply referred to as “P1”, “P2”, “P3”, and “P4”, respectively. First, the travel path of the green-color light component will be described. The green-color light beam emerging from P1 is transmitted again through P2, and then is incident to a reflective LCD denoted by the reference numeral 15G. The green-color light beam incident to the reflective LCD 15G is converted into S waves while being reflected by the reflective LCD 15G in an image-contained state. As a result, the green-color light beam is reflected by P2, and directed to P4. The green-color light beam reaching P4 is also reflected by P4, so that it is directed to a projection unit 16. In the procedure in which the green-color light beam travels from P4 to the projection unit 16, the green-color light beam is converted into P waves while passing through the green-color selecting retarder GR so as to allow its polarization condition to coincide with those of other color components.

On the other hand, the red-color light beam reflected by P1 is converted into P waves while passing through a red-color selecting retarder RR. Accordingly, the red-color light beam can be transmitted through P3, and then incident to a reflective LCD 15R. The red-color light beam incident to the reflective LCD 15R is converted into S waves while being reflected by the reflective LCD 15R in an image-contained state. As a result, the red-color light beam is reflected by P3, and then directed to P4. Since the red-color selecting retarder RR is arranged between P3 and P4, the red-color light beam, which is converted into S waves while being reflected by the reflective LCD 15R reaching P4, is converted again into P waves. Accordingly, the red-color light beam is transmitted through P4, and then directed to the projection unit 16.

The blue-color light beam reflected by P1 is reflected by P3 because it has an S-polarized state. This blue-color light beam reflected by P3 is then incident to a reflective LCD 15B. The blue-color light beam incident to the reflective LCD 15B is converted into P waves while being reflected by the reflective LCD 15B in an image-contained state. As a result, the blue-color light beam is transmitted through P3 and P4, irrespective of the color selecting retarders, so that it is directed to the projection unit 16.

Where such a Color Quad™ is used as the color separating/synthesizing unit of the above mentioned projection system, one reflective LCD is arranged at one side surface of the light exit. For this reason, it is required to simplify the design of the projection unit as much as possible in order to minimize the occurrence of an interference phenomenon.

In order to meet the above requirement, it is necessary for the projection unit to be spaced apart from the Color Quad™ by a considerable distance. In this case, however, there is a problem in that the projection system has an increased volume. Where this configuration is applied to a compact projection system, there is a problem in that outgoing light beams interfere with each other at the reflective LCD.

FIG. 4 briefly illustrates a conventional projection system using an X-prism as its color synthesizing/synthesizing unit. Non-polarized white light emitted from a lamp 11 is directed to a polarization means (not shown) which, in turn, splits the light into S and P waves, thereby generating polarized illumination light beams. The polarized S waves are then incident to a polarized beam splitter 13. The polarized beam splitter 13 completely reflects the incident polarized S waves in accordance with its characteristics. The reflected light is then directed to an X-prism 14.

The light incident to the X-prism 14 is splitted into R, G, and B-color components which are, in turn, reflected by respective reflective liquid crystal panels 15R, 15G, and 15B. Thereafter, the R, G, and B-color light beams are incident again to the polarized beam splitter 13 along the same optical path.

When a liquid crystal is at its ON state, the light beam modulated into an image by the region of the reflective liquid crystal panel 15R, 15G, or 15B associated with the liquid crystal is emitted in a state in which its polarization direction is rotated by 90°. In other words, an incident S-polarized light beam is converted into a P-polarized light beam while being reflected. As a result, the light beam corresponding to the ON-state region is transmitted through the polarized beam splitter 13, and then projected onto a screen (not shown) through a projection lens 16, thereby forming an image.

Although the color separating/synthesizing unit having the X-prism configuration illustrated in FIG. 4 is likely to have a simple configuration capable of being advantageous to a miniature, as compared to other configurations as mentioned above, it cannot practically realize a desired performance of projection systems, using known techniques. Practically, desired functions of projection systems are obtained in so far as three polarized beam splitters and three dichroic filters are used, in addition to an X-prism having the configuration shown in FIG. 5.

Thus, where such an X-prism is used as the color synthesizing/synthesizing unit of the projection system illustrated in FIG. 5, it is necessary to appropriately combine and arrange a plurality of constituting elements, thereby resulting in a complicated structure and an increased volume. As a result, there is a degradation in competitiveness.

### SUMMARY OF THE INVENTION

Therefore, an object of the invention is to eliminate the above mentioned problems, and to provide a color separating/synthesizing apparatus which is configured to avoid a degradation in contrast depending on the performance of its polarized beam splitter, to eliminate the cause of the requirement of simplifying the design of its projection unit as much as possible in order to minimize the occurrence of an interference phenomenon involved in the case in which one reflective LCD is arranged at one side surface of a light exit, and to allow incident and outgoing light beams to have a relation of 90°, thereby allowing its projection lens to have a more compact mechanical position.

In accordance with the present invention, this object is accomplished by providing a color separating/synthesizing apparatus comprising: a light component separating unit for reflecting a selected one of light components, included in an incident light emitted from a light source, in a direction perpendicular to a travel path of the incident light while allowing the remaining light components to be transmitted therethrough along the travel path of the incident light; a first synthesizing unit for receiving the light components transmitted through the light component separating unit, and separating the received light components from each other, the first synthesizing unit also serving to form images respectively corresponding to the separated light components via a first LCD and a second LCD, to synthesize the images, and to allow the synthesized image to be directed in a direction perpendicular to the incident light introduced into the dichroic filter; a second synthesizing unit for receiving the light component reflected from the light component separating unit, forming an image corresponding to the received light component via a third LCD, and reflecting the image in a direction parallel to the travel path of the incident light introduced into the dichroic filter; and a third synthesizing unit for synthesizing light beams respectively containing the images formed in the first and second synthesizing units, and allowing the synthesized light to be directed in the direction perpendicular to the incident light introduced into the dichroic filter.

The light component separating unit may comprise: a first color selecting retarder for allowing the incident light emitted from the light source to be transmitted therethrough while converting the selected light beam into an S-polarized state; and a first polarized beam splitter for reflecting the S-polarized light component of the light transmitted through the first color selecting retarder while allowing the remaining components of the transmitted light to be transmitted therethrough.

The first synthesizing unit may comprise: a second color selecting retarder for converting a selected one of light components, included in the light transmitted through the light component separating unit, into S waves; a second polarized beam splitter for reflecting an S-polarized component of the light transmitted through the second color selecting retarder while allowing the remaining component of the transmitted light to be transmitted therethrough; the first LCD for reflecting the S-polarized light reflected by the second polarized beam splitter while forming an image corresponding to the S-polarized light incident thereto and converting the polarized state of the S-polarized light into P waves, the first LCD also serving to allow the reflected P-polarized light to be directed to the second polarized beam splitter; the second LCD for reflecting the P-polarized light transmitted through the second polarized beam splitter while forming an image corresponding to the P-polarized light incident thereto and converting the polarized state of the P-polarized light into S waves, the second LCD also serving to allow the reflected S-polarized light to be directed to the second polarized beam splitter, thereby allowing the S-polarized light to be synthesized, in the second polarized beam splitter, with the P-polarized light directed to the second polarized beam splitter; and a third color selecting retarder for allowing a light, resulting from the synthesis of the S and P-polarized light beams directed to the second polarized beam splitter, to be transmitted therethrough when the light travels in the direction perpendicular to the incident light introduced into the dichroic filter, while converting an S-polarized component of the light into P waves.

The second synthesizing unit may comprise: a third polarized beam splitter for reflecting the light beam reflected by the light component separating unit; a third LCD for reflecting the light transmitted through the third polarized beam splitter while forming an image corresponding to the light incident thereto and converting the polarized state of the P-polarized light into P waves, the third LCD also serving to allow the reflected P-polarized light to be directed to the third polarized beam splitter so that the light directed to the third polarized beam splitter is directed in parallel to the travel path of the incident light introduced into the light component separating unit; and a third color selecting retarder for converting the polarized state of the light transmitted through the third polarized beam splitter into S waves.

The third synthesizing unit may comprise a fourth polarized beam splitter for allowing the light emerging from the first synthesizing unit to be transmitted therethrough while reflecting the light emerging from the second synthesizing unit, thereby allowing all the light beams to be directed in the direction perpendicular to the travel direction of the incident light introduced into the light component separating unit.

The color separating/synthesizing apparatus may further comprise a polarization plate arranged on a travel path of the light emerging from the light component separating unit and adapted to allow an S-polarized component of the light to be transmitted therethrough.

The color separating/synthesizing may further comprise a fifth color selecting retarder adapted to allow the light components synthesized by the third synthesizing unit to have the same polarized state.

### BRIEF DESCRIPTION OF THE DRAWINGS

The above objects, and other features and advantages of the present invention will become more apparent after a reading of the following detailed description when taken in conjunction with the drawings, in which:

FIG. 1 is a schematic view illustrating a conventional projection system using a Color Coner™ as its color synthesizing/synthesizing unit;

FIG. 2 is a schematic view illustrating a conventional projection system using a Philips prism as its color synthesizing/synthesizing unit;

FIG. 3 is a schematic view illustrating a conventional projection system using a Color Quad™ as its color separating/synthesizing unit;

FIG. 4 is a schematic view illustrating a conventional projection system using an X-prism as its color synthesizing/synthesizing unit;

FIG. 5 is a schematic view illustrating the configuration of a practically-applicable X-prism;

FIG. 6 is a schematic view illustrating a projection system to which a color separating/synthesizing apparatus according to an embodiment of the present invention is applied; and

FIG. 7 is a schematic view illustrating a projection system to which a color separating/synthesizing apparatus using S-polarized components of incident light in accordance with another embodiment of the present invention, as compared to the case of FIG. 6, is applied.

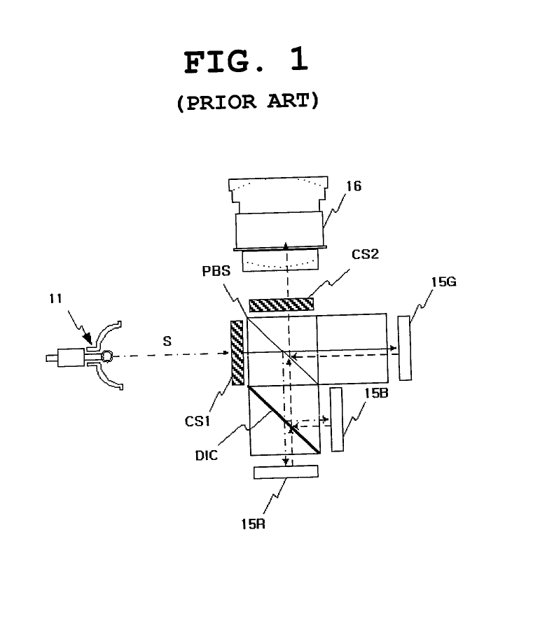

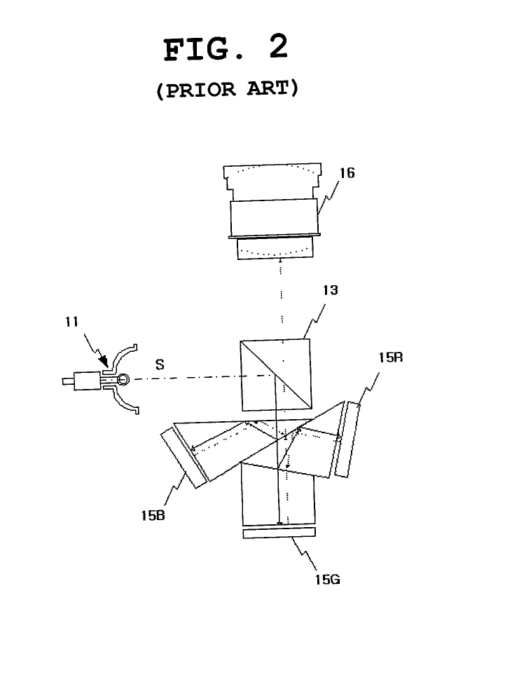

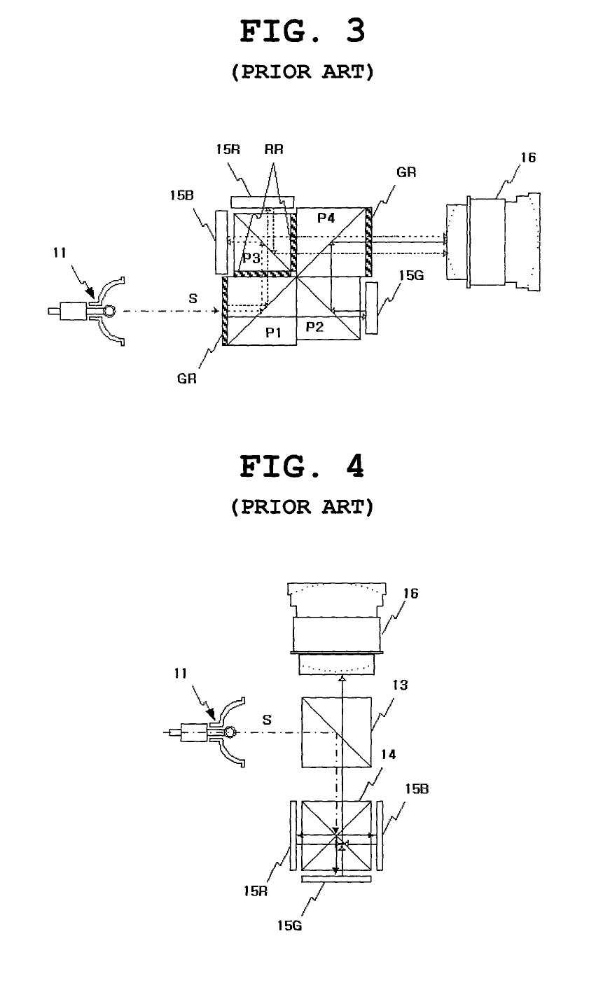

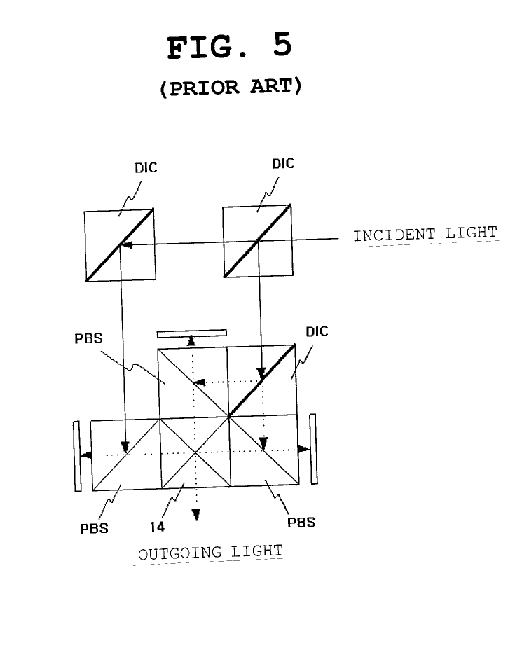

### DESCRIPTION OF THE PREFERRED EMBODIMENTS

Now, preferred embodiments of the present invention will be described in conjunction with the annexed drawings.

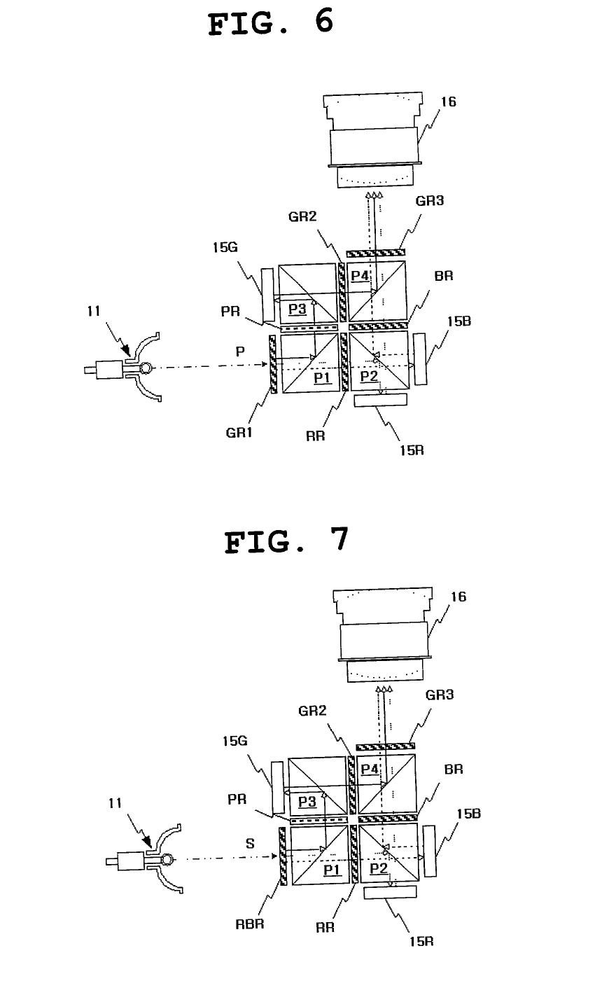

FIG. 6 briefly illustrates a projection system to which a color separating/synthesizing apparatus according to an embodiment of the present invention is applied. The operation of the color separating/synthesizing apparatus will be described with reference to the configuration of FIG. 6.

Light emitted from a lamp 11 is incident to a polarization means (not shown) which, in turn, extracts only P waves from the incident light. The P-polarized light passing through the polarization means is incident to a first green-color selecting retarder GR1 which converts only the green-color component of the incident light into S waves. The green-color light beam emerging from the green-color selecting retarder GR1 is then directed to an associated one of four polarized beam splitters, that is, a polarized beam splitter P1.

The polarized beam splitter P1 reflects the green-color component of the light incident thereto while allowing the remaining blue and red-color components of the incident light to be transmitted therethrough. The blue and red-color components transmitted through the polarized beam splitter P1 are then incident to a red-color selecting retarder RR which, in turn, converts red-color components of the incident light into S waves. The S-polarized light beam is then directed to an associated one of the four polarized beam splitters, that is, a polarized beam splitter P2.

Thus, respective R, G, and B-color components of light have different travel paths by virtue of the polarized beam splitters. In the following description, the four polarized beam splitters included in the color synthesizing/synthesizing apparatus will be simply referred to as “P2”, “P3”, and “P4”, respectively. First, the travel path of the green-color light component will be described. The green-color light beam reflected by P1 is transmitted through a polarizer PR while being filtered to have only S-polarized components. The S-polarized light is then directed to P3.

Since the green-color light beam has an S-polarized state, it is reflected by P3, and then directed to a reflective LCD 15G. The green-color light beam incident to the reflective LCD 15G is converted into P waves while being reflected by the reflective LCD 15G in an image-contained state. As a result, the green-color light beam is transmitted through P3, and directed to P4. Since a second green-color selecting retarder GR2 is arranged between P3 and P4, the green-color light beam is converted again into S waves. Accordingly, the green-color light beam is reflected by P4, and then directed to a projection unit 16.

In the procedure in which the green-color light beam travels from P4 to the projection unit 16, the green-color light beam is converted into P waves while passing through a third green-color selecting retarder GR3 so as to allow its polarization condition to coincide with those of other color components.

On the other hand, the red-color light beam transmitted through P1 is converted into S waves while passing through the red-color selecting retarder RR. As a result, the red-color light beam is allowed to be reflected by P2. This red-color light beam reflected by P2 is then incident to a reflective LCD 15R. The red-color light beam incident to the reflective LCD 15R is converted again into P waves while being reflected by the reflective LCD 15R in an image-contained state. As a result, the red-color light beam is transmitted to P4 via P2. Although a blue-color selecting retarder BR is arranged between P2 and P4, the P-polarized red-color light beam is not influenced by the blue-color selecting retarder BR. Therefore, the red-color light beam is directed to the projection unit 16 via P4 in a P-polarized state without any change in the polarization state thereof.

Of course, the red-color light beam is not influenced by the third green-color selecting retarder GR3.

The blue-color light beam transmitted through P1 is also transmitted through P2 because it has a P-polarized state. The blue-color light beam emerging from P2 is then incident to a reflective LCD 15B. The blue-color light beam incident to the reflective LCD 15B is converted into S waves while being reflected by the reflective LCD 15B in an image-contained state. As a result, the blue-color light beam emerging from the reflective LCD 15B is reflected by P2, and then directed to P4. Since a blue-color selecting retarder BR is arranged between P2 and P4, the blue-color light beam is converted from S waves to P waves before it reaches P4. Accordingly, the blue-color light beam is transmitted through P4, and then directed to the projection unit 16.

The above mentioned embodiment of the present invention is associated with the case in which the polarized state of light does not correspond to S waves, but corresponds to P waves. In this case, it is possible to achieve an improvement in characteristics while using a more simple configuration because no or little S waves are mixed with P waves transmitted through the polarized beam splitter, by virtue of the characteristics of the polarized beam splitter.

Of course, the present invention may be implemented in the case in which S waves are used, in place of P waves, as compared to the case illustrated in FIG. 6. This is illustrated in FIG. 7.

The color separating/synthesizing apparatus of FIG. 7 has the same configuration as that of FIG. 6, except that the first green-color selecting retarder GR1 used in the case of FIG. 6 is substituted by a red and blue-color selecting retarder RBR.

Now, the operation of the color separating/synthesizing apparatus illustrated in FIG. 7 will be described. Light emitted from a lamp 11 is incident to a polarization means (not shown) which, in turn, extracts only S waves from the incident light. The S-polarized light passing through the polarization means is incident to a red and blue-color selecting retarder RBR which converts the color components of the incident light, other than the green-color components, into P waves. The light emerging from the red and blue-color selecting retarder RBR is then directed to an associated one of four polarized beam splitters, that is, a polarized beam splitter P1.

The polarized beam splitter Pi reflects the green-color component of the light incident thereto while allowing the remaining blue and red-color components of the incident light to be transmitted therethrough. The blue and red-color components transmitted through the polarized beam splitter Pi are then incident to a red-color selecting retarder RR which, in turn, converts red-color components of the incident light into S waves. The S-polarized light beam is then directed to an associated one of the four polarized beam splitters, that is, a polarized beam splitter P2.

Thus, respective R, G, and B-color components of light have different travel paths by virtue of the polarized beam splitters. In the following description, the four polarized beam splitters included in the color synthesizing/synthesizing apparatus will be simply referred to as “P1”, “P2”, “P3”, and “P4”, respectively. First, the travel path of the green-color light component will be described. The green-color light beam reflected by Pi is transmitted through a polarizer PR while being filtered to have only S-polarized components. The S-polarized light is then directed to P3.

Since the green-color light beam has an S-polarized state, it is reflected by P3, and then directed to a reflective LCD 15G. The green-color light beam incident to the reflective LCD 15G is converted into P waves while being reflected by the reflective LCD 15G in an image-contained state. As a result, the green-color light beam is transmitted through P3, and directed to P4. Since a second green-color selecting retarder GR2 is arranged between P3 and P4, the green-color light beam is converted again into S waves. Accordingly, the green-color light beam is reflected by P4, and then directed to a projection unit 16.

In the procedure in which the green-color light beam travels from P4 to the projection unit 16, the green-color light beam is converted into P waves while passing through a third green-color selecting retarder GR3 so as to allow its polarization condition to coincide with those of other color components.

On the other hand, the red-color light beam transmitted through P1 is converted into S waves while passing through the red-color selecting retarder RR. As a result, the red-color light beam is allowed to be reflected by P2. This red-color light beam reflected by P2 is then incident to a reflective LCD 15R. The red-color light beam incident to the reflective LCD 15R is converted again into P waves while being reflected by the reflective LCD 15R in an image-contained state. As a result, the red-color light beam is transmitted to P4 via P3. Although a blue-color selecting retarder BR is arranged between P3 and P4, the P-polarized red-color light beam is not influenced by the blue-color selecting retarder BR. Therefore, the red-color light beam is directed to the projection unit 16 via P4 in a P-polarized state without any change in the polarization state thereof.

Of course, the red-color light beam is not influenced by the third green-color selecting retarder GR3.

The blue-color light beam transmitted through P1 is also transmitted through P2 because it has a P-polarized state. The blue-color light beam emerging from P2 is then incident to a reflective LCD 15B. The blue-color light beam incident to the reflective LCD 15B is converted into S waves while being reflected by the reflective LCD 15B in an image-contained state.

As a result, the blue-color light beam emerging from the reflective LCD 15B is reflected by P2, and then directed to P4. Since a blue-color selecting retarder BR is arranged between P2 and P4, the blue-color light beam is converted from S waves to P waves before it reaches P4. Accordingly, the blue-color light beam is transmitted through P4, and then directed to the projection unit 16.

As apparent from the above description, the present invention provides a color separating/synthesizing apparatus which is configured to avoid a degradation in contrast depending on the performance of its polarized beam splitter, to eliminate the cause of the requirement of simplifying the design of its projection unit as much as possible in order to minimize the occurrence of an interference phenomenon involved in the case in which one reflective LCD is arranged at one side surface of a light exit, and to allow incident and outgoing light beams to have a relation of 90°, thereby allowing its projection lens to have a more compact mechanical position.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. A color separating/synthesizing apparatus comprising:
a light component separating unit for reflecting a selected one of light components, included in an incident light emitted from a light source, in a direction perpendicular to a travel path of the incident light while allowing the remaining light components to be transmitted therethrough along the travel path of the incident light;
a first synthesizing unit for receiving the light components transmitted through the light component separating unit, and separating the received light components from each other, the first synthesizing unit also serving to form images respectively corresponding to the separated light components via a first LCD and a second LCD, to synthesize the images, and to allow the synthesized image to be directed in a direction perpendicular to the incident light introduced into the dichroic filter;
a second synthesizing unit for receiving the light component reflected from the light component separating unit, forming an image corresponding to the received light component via a third LCD, and reflecting the image in a direction parallel to the travel path of the incident light introduced into the dichroic filter; and
a third synthesizing unit for synthesizing light beams respectively containing the images formed in the first and second synthesizing units, and allowing the synthesized light to be directed in the direction perpendicular to the incident light introduced into the dichroic filter.

2. The color separating/synthesizing apparatus according to claim 1, wherein the light component separating unit comprises:
a first color selecting retarder for allowing the incident light emitted from the light source to be transmitted therethrough while converting the selected light beam into an S-polarized state; and
a first polarized beam splitter for reflecting the S-polarized light component of the light transmitted through the first color selecting retarder while allowing the remaining components of the transmitted light to be transmitted therethrough.

3. The color separating/synthesizing apparatus according to claim 1, wherein the first synthesizing unit comprises:
a second color selecting retarder for converting a selected one of light components, included in the light transmitted through the light component separating unit, into S waves;
a second polarized beam splitter for reflecting an S-polarized component of the light transmitted through the second color selecting retarder while allowing the remaining component of the transmitted light to be transmitted therethrough;
the first LCD for reflecting the S-polarized light reflected by the second polarized beam splitter while forming an image corresponding to the S-polarized light incident thereto and converting the polarized state of the S-polarized light into P waves, the first LCD also serving to allow the reflected P-polarized light to be directed to the second polarized beam splitter;
the second LCD for reflecting the P-polarized light transmitted through the second polarized beam splitter while forming an image corresponding to the P-polarized light incident thereto and converting the polarized state of the P-polarized light into S waves, the second LCD also serving to allow the reflected S-polarized light to be directed to the second polarized beam splitter, thereby allowing the S-polarized light to be synthesized, in the second polarized beam splitter, with the P-polarized light directed to the second polarized beam splitter; and
a third color selecting retarder for allowing a light, resulting from the synthesis of the S and P-polarized light beams directed to the second polarized beam splitter, to be transmitted therethrough when the light travels in the direction perpendicular to the incident light introduced into the dichroic filter, while converting an S-polarized component of the light into P waves.

4. The color separating/synthesizing apparatus according to claim 1, wherein the second synthesizing unit comprises:
a third polarized beam splitter for reflecting the light beam reflected by the light component separating unit;
a third LCD for reflecting the light transmitted through the third polarized beam splitter while forming an image corresponding to the light incident thereto and converting the polarized state of the P-polarized light into P waves, the third LCD also serving to allow the reflected P-polarized light to be directed to the third polarized beam splitter so that the light directed to the third polarized beam splitter is directed in parallel to the travel path of the incident light introduced into the light component separating unit; and
a third color selecting retarder for converting the polarized state of the light transmitted through the third polarized beam splitter into S waves.

5. The color separating/synthesizing apparatus according to claim 1, wherein the third synthesizing unit comprises a fourth polarized beam splitter for allowing the light emerging from the first synthesizing unit to be transmitted therethrough while reflecting the light emerging from the second synthesizing unit, thereby allowing all the light beams to be directed in the direction perpendicular to the travel direction of the incident light introduced into the light component separating unit.

6. The color separating/synthesizing apparatus according to claim 1, further comprising:
a polarization plate arranged on a travel path of the light emerging from the light component separating unit and adapted to allow an S-polarized component of the light to be transmitted therethrough.

7. The color separating/synthesizing apparatus according to claim 1, further comprising:
a fifth color selecting retarder adapted to allow the light components synthesized by the third synthesizing unit to have the same polarized state.
